(19) United States
(12) Patent Application Publication
(10) Pub. No.: US 2007/0281056 A1
(43) Pub. Date: Dec. 6, 2007

(54) Premixes, Flour Enriched With Same, Mineral Supplemented Foodstuffs And Methods Of Manufacture Thereof

(75) Inventors: Brian Anthony Whittle, Bedfordshire (GB); Paul Marcus Hart, Northants (GB)

Correspondence Address: DICKINSON WRIGHT PLLC, 38525 WOODWARD AVENUE, SUITE 2000, BLOOMFIELD HILLS, MI, 48304-2970, US

(73) Assignee: NUTRACEUTICALS LIMITED, RENHOLD, BEDFORDSHIRE (GB)

(21) Appl. No.: 11/660,062

(22) PCT Filed: Aug. 11, 2005
(86) PCT No.: PCT/GB05/03163

§ 371 Date: May 29, 2007

(30) Foreign Application Priority Data
Aug. 13, 2004 (GB) 0418109.5

(51) Int. Cl. A23L 1/303; A21D 10/00; A21D 2/02; A23L 1/304; A23L 1/30

(52) U.S. Cl. 426/73; 426/311; 426/555; 426/72; 426/74

(57) ABSTRACT

Premixes, flour enriched with same, mineral supplemented foodstuffs and methods of manufacture thereof. The present invention relates to a premix for addition to foodstuffs and more particularly farinaceous products and bread. Use of the premix in foodstuffs enables their nutritional and mineral content to be enhanced providing health benefits and more particularly improved bone health.

### TECHNICAL FIELD OF THE INVENTION

The present invention relates to mineral fortified farinaceous products such as for example, bread, premixes for achieving fortification and methods and processes for making the same.

### BACKGROUND TO THE INVENTION

Calcium and magnesium are essential mineral components of bone. Approximately 60% of the dry weight of bone consists of calcium hydroxyapatite, a microcrystalline form of calcium. Magnesium forms part of the inorganic scaffold of bone with hydroxyapatite and also enhances the absorption and proper deposition of calcium. The mineral content of bone is not static and is affected by continual deposition and re-absorption of these minerals. Development and maintenance of skeletal health is essential and deficiency of these minerals in the diet may lead to poor bone health and an increased risk of fracture.

Adult bone health is predominantly governed by two factors: (i) maximum attainment of peak bone mass and (ii) rate of bone loss which occurs with ageing. Genetic influences may account for up to three quarters of the variation in bone mass. However, a number of other physiological factors are involved in the control of osteogenesis and osteoclastogenesis—the processes that signal deposition and removal of minerals from bone—proving there is still room for modifiable factors such as nutrition.

There exists good evidence to show that calcium is not only important in attaining peak bone mass but also in reducing bone loss. Osteoporosis is the most common form of metabolic bone disease and is a part of the aging process. From early adulthood there is a progressive loss of mineral from the bone approaching 1% per annum. Studies have indicated that bone mineral density can be increased with higher calcium intakes. In the elderly, fracture rate is lower in those with a higher calcium and vitamin D intake. A low intake of calcium and magnesium particularly in adolescence has also been highlighted as a risk factor in Osteoporosis.

Currently there is no international consensus as to recommendations for calcium intake. In the UK, the report by the committee on Medical Aspects of Food Policy (COMA), recommended intakes of 700 mg per day for adults aged 19-50 years. The Recommended Daily Amount (RDA) of calcium in Europe is 800 mg and a US report recommended as much as 1000 mg. In part this variation is due to the methodology used to arrive at the recommendations but also because different sectors of the population have higher needs at various times throughout life for example during pregnancy and lactation or during childhood and adolescence when bone growth is at a maximum—indeed there are suggested RDA's for these subsets of the general population.

Table 1 shows the RDA for a variety of Minerals, Vitamins and Trace elements.

| Micronutrient | EU labelling RDA | |
|---|---|---|
| Calcium | 800 | mg |
| Magnesium | 300 | mg |
| Phosphorous | 800 | mg |
| Vitamin D | 5 | μg |
| Vitamin A | 800 | μg |
| Vitamin E | 10 | mg |
| Beta-carotene | — | |
| Vitamin B1: Thiamin | 1.4 | mg |
| Vitamin B2: Riboflavin | 1.6 | mg |
| Vitamin B3: Nicotinamide | 18 | mg |
| Vitamin B3: Nicotinicacid | 18 | mg |
| Pantothenic acid | 6 | mg |
| Vitamin B6 | 2 | mg |
| Vitamin B12 | 1 | μg |
| Folic acid | 200 | μg |
| Biotin | 150 | μg |
| Vitamin C | 60 | mg |
| Iodine | 150 | μg |
| Iron | 14 | mg |
| Zinc | 15 | mg |

| | |
|---|---|
| Copper | — |
| Chromium | — |
| Manganese | — |
| Molybdenum | — |
| Selenium | — |
| (Based on EC directive 90/496/EEG) | —: no RDA fixed |

Adequate provision of calcium is well understood but the requirement for magnesium is less widely known. Since both minerals are important components of bone it is appropriate to provide a balanced composition of calcium and magnesium. Additionally magnesium has a synergistic role in calcium absorption and deficiency alters calcium metabolism and affects the hormone that regulates calcium.

It may also be useful to provide a source of phosphorous more preferably in the form of phosphate. Human bone has a 2:1 ratio of calcium to phosphorous and phosphorous deficiency may make calcium supplementation less effective.

In addition to its role in bone health, calcium is important in a wide range of other physiological processes such as nerve function and muscle contraction. Magnesium also plays a crucial role in activating 80-100 enzymes in the body and is also key in general nerve and muscle function.

Vitamin D is important in the regulation of calcium and phosphate metabolism and affects intestinal absorption of these minerals and others such as magnesium. For example, people lacking in vitamin D may absorb less than 10% of the bio-available dietary calcium. Vitamin D deficiency is known to cause rickets in infants and children and osteomalacia in adults as well as being a factor associated with bone fracture risk.

Vitamin D is an important prohormone which is mainly formed by synthesis in the skin under the influence of sunlight. It is found in only a few foodstuffs, fatty fish and fish oils, liver, milk and eggs being the main dietary sources.

However, these nutritional sources alone cannot provide sufficient amounts of vitamin D to meet the required daily amount. Certain groups such as people with dark skin, those who are institutionalised and even people who use high factor sunscreens regularly may not synthesise sufficient vitamin D and are at an increased risk of deficiency.

The preferred approach to attaining an optimal calcium and magnesium intake is through dietary sources. It should be noted that although many foods are rich in calcium for example milk, milk products, meat, fish, and eggs, they also have a tendency to have much lower levels of magnesium and phosphorous. This problem can be corrected by offering a supplement which contains a source of both minerals in absorbable form.

To a large extent mineral supplementation has focussed on beverages and their fortification with calcium and other vitamins and minerals. U.S. Pat. No. 5,597,595 and U.S. Pat. No. 5,609,897 disclose liquid beverage concentrates and powdered beverage concentrates respectively. Both beverage formulations contain calcium glycerophosphate and vitamin D. However these publications disclose beverage concentrates with a calcium level of only 7.2-18% on a dry weight basis prior to dilution. They do not teach the use of higher calcium levels or the use of magnesium or phosphorous, nor do they teach the fortification of other foodstuffs.

U.S. Pat. No. 6,461,650 discloses preparations containing soluble forms or suspensions of calcium and magnesium for supplementation of acidic beverages with a pH from 2.5-4.5. It does not disclose the supplementation of other foodstuffs nor does this document disclose the use of calcium or magnesium alone or in combination with other minerals or vitamin D.

U.S. Pat. No. 5,698,222 discloses dietary supplements of calcium and vitamin D in solid form with vegetable oils and their use in low pH Beverages. It does not teach the use of such a supplement as a premix for use in other foodstuffs such as farinaceous products. It does not disclose the use of other minerals and vitamins to enhance calcium absorption.

U.S. Pat. No. 5,654,011 discloses a dietary supplement for women. It does not teach the use of such a supplement in dietary staple food products or the use of said supplement by the general population as a whole.

U.S. Pat. No. 6,558718 discloses nutrient clusters for addition to Ready-to-Eat cereals. It does not teach the use of such clusters for other foodstuffs.

U.S. Pat. No. 6,569,445 teaches the preparation of foodbars for enhancing the nutrition of pregnant or lactating women and women of childbearing potential. This publication does not disclose supplementation for enhancing bone health or for use by the general population.

U.S. Pat. No. 5,945,144 teaches the supplementation of pasta with calcium. It does not disclose the use of other minerals or vitamins to enhance the absorption of calcium or disclose problems resulting from high calcium levels such as constipation or knock-on effects in terms of mineral deficiencies. It does not teach the use of Calcium in more ‘complex’ food products such as farinaceous products which undergo ‘reactions with yeast’.

### DISCLOSURE OF THE INVENTION

The present invention relates to a premix for addition to foodstuffs and more particularly farinaceous products and bread. Use of the premix in foodstuffs enables their nutritional and mineral content to be enhanced providing health benefits and more particularly improved bone health.

Unfortunately the taste or inconvenience of taking vitamin and mineral supplements may discourage subjects from taking them on a regular basis. Simple salts of calcium and magnesium such as chloride or sulphate can impart a brackish taste. Parents may also find it difficult to persuade children to take supplements routinely. Therefore a way to introduce supplementation with minerals in a form which is effective, unobtrusive and free of objectionable taste implications is required.

Most work in this field has concentrated on supplementation of beverages, relatively little has been done in terms of increasing the nutritional value of ‘dietary staples’ such as bread. Part of the reasoning behind this may be due to the relative ease with which minerals and vitamins can be formulated into drinks. An objective of the present invention therefore, was to develop dietary staples or intermediates with enhanced nutritional quality, particularly in the area of bone health. To meet this objective premixes for addition to foodstuffs, more particularly dietary staples, bakery products, bread and flour, were developed.

According to a first aspect of the present invention there is provided a premix consisting essentially of minerals including at least one source of calcium and a source of vitamin D.

Typically a premix is a concentrated mixture of ingredients supplied to a manufacturer in fixed unit quantities. The premix is typically diluted by addition to other components during production. For example a premix of minerals may be diluted with flour to attain a particular concentration of those minerals in a final product such as bread. Use of a premix allows for a uniform dose to be added during production processes improving ease of use and handling and increasing quality control.

Making a premix typically involves a specialised process of identifying the right form of ingredients by considering their physical properties. Such physical properties could include for example bulk densities, particle size and shape, flowability, compatibility and possible chemical interactions with other ingredients and distribution within the food product to be fortified.

The term ‘consisting essentially’ refers to the mineral content of the premix. It is preferred that the premixes of the present invention have a mineral content of not less than 70% by weight and more preferably not less than 80% by weight and most preferably not less than 90% by weight. More preferably the mineral contents are calcium, magnesium, phosphorous or iron.

In order to achieve a premix that is acceptable to consumers, the inventors have found that the source(s) of minerals and other vitamins is significant. Not all mineral sources can be utilised as an ingredient in the premix of the present invention. The mineral and vitamin sources used must be acceptable for food use, typically with an E number. In addition the combinations of minerals must be carefully selected as some forms of calcium and magnesium possess particular synergies when combined and also affect the quality or taste of dough or end product within which the premix is contained.

As used herein the term calcium used alone refers to elemental calcium, the term calcium salt refers to a chemical composition containing elemental calcium and calcium source (or source of calcium) refers to calcium and/or calcium salt. In reference to other minerals the above terminology is also applicable.

The calcium salt that is utilised may be an inorganic salt or an organic salt. Examples of calcium sources include calcium acetate, calcium magnesium acetate, calcium alginate, calcium ascorbate, calcium benzoate, calcium butyrate, calcium carbonate, calcium magnesium carbonate, calcium chloride, calcium citrate, calcium magnesium citrate, calcium cyclamate, calcium diglutamate, calcium formate, calcium fumarate, calcium gluconate, calcium glycerophosphate, calcium hydroxide, calcium hydroxide carbonate, calcium iodate, calcium lactate, calcium lactate gluconate, calcium malates, calcium malonate, calcium oleate, calcium oxalate, calcium oxide, calcium palmitate, calcium phosphate (tribasic), calcium monohydrogen phosphate (dibasic), calcium dihydrogen phosphate (monobasic), calcium Phosphite, calcium phytate, calcium polyphosphate, calcium pyrophosphate, calcium proprionate, calcium D-saccharate, calcium silicate, calcium sorbate, calcium stearate, calcium stearoyl-2-lactylate, calcium succinate, calcium sulphate, calcium tartrate and calcium valerate.

The preferred salts are calcium chloride, calcium citrate, calcium carbonate (including creta praeparatum), calcium oxide, calcium phosphate (tribasic), calcium phosphate (monobasic: monocalcium phosphate monohydrate, calcium dihydrogen phosphate), calcium phosphate (dibasic: calcium monohydrogen phosphate) and calcium magnesium carbonate (including dolomite).

Unfortunately one cannot simply modify the level of one ingredient without concomitantly affecting other organoleptic and health properties. Increasing the levels of calcium in the diet may cause constipation limiting the amount by which foodstuffs may be supplemented. The inventors have found that by additionally supplementing with magnesium they can reverse the constipatory effect enabling greater levels of calcium supplementation.

In a preferred embodiment the premix further comprises at least one source of magnesium.

The magnesium salt that is utilised may be an inorganic or an organic salt. Examples of magnesium source include magnesium acetate, magnesium butyrate, magnesium carbonates, magnesium carbonate hydroxide, magnesium chloride, magnesium citrate, magnesium citrate (dibasic), magnesium formate, magnesium fumarate, magnesium hydroxide, magnesium hydroxide carbonate, magnesium lactate, magnesium malate, magnesium malonates, magnesium oxalate, magnesium oxide, magnesium phosphate (tribasic), magnesium monohydrogen phosphate (dibasic), magnesium dihydrogen phosphate (monobasic), magnesium phytate, magnesium Phosphite, magnesium polyphosphate, magnesium proprionate, magnesium pyrophosphate, magnesium succinate, magnesium sulphate, magnesium stearate, magnesium tartrate and magnesium valerate. It is also preferred that the magnesium salt is substantially anhydrous.

The preferred salts are magnesium sulphate, magnesium sulphate (exsiccated), magnesium chloride, magnesium citrate, magnesium carbonate, magnesium phosphate (tribasic), magnesium phosphate (dibasic: magnesium monohydrogen phosphate, dimagnesium phosphate trihydrate) magnesium phosphate (monobasic: magnesium dihydrogen phosphate) and more preferably calcium magnesium carbonate and dimagnesium phosphate trihydrate.

In some embodiments it may be preferred that the chosen form(s) of mineral(s) will be substantially anhydrous and have a desiccant effect. This has the favourable quality of maintaining the premix or for example flour containing said premix, as a free-flowing powder.

In other embodiments it may be preferred that the chosen form(s) of mineral(s) be dissolved or dispersed in a solution. This has the favourable quality of allowing faster incorporation when added to other ingredients.

In yet further embodiments it may be preferred that the chosen form(s) of mineral(s) will have further beneficial properties. For example calcium carbonates, calcium phosphates and calcium sulphates are used to regulate water hardness and typically control dough swelling, help activate flour enzymes and provide nutrient for yeast activity. Calcium acetate, calcium lactate and calcium proprionate have antimicrobial effects which typically reduce spoilage and extend product shelf life. Calcium stearoyl 2-lacylate helps to improve fermentation tolerance and volume.

As calcium intake increases, total phosphorous absorption decreases which may cause a phosphorous deficiency. Phosphorous is also needed for effective calcium absorption.

In a preferred embodiment the premix further comprises at least one source of phosphorous.

The preferred forms of phosphorous are the phosphates and more preferably the calcium and magnesium phosphates such as magnesium phosphate dibasic (trihydrate), magnesium phosphate monobasic (trihydrate), magnesium phosphate tribasic (pentahydrate), magnesium phosphate and magnesium pyrophosphate (trihydrate), calcium phosphate monobasic (monohydrate), calcium phosphate dibasic, calcium phosphate tribasic and calcium pyrophosphate.

Thus in a particularly preferred embodiment the premix comprises a calcium and/or magnesium phosphate.

In yet another embodiment the premix further comprises at least one source of iron.

The preferred source of iron is micronised elemental iron more preferably in particulate form but other mineral salts may be used such as the ferric or ferrous salts including iron fumarate, ferric pyrophosphate, iron sulphate and ammonium ferric citrate.

In yet another embodiment the premix further comprises other sources of vitamins, Minerals or Trace elements such as one or more from: vitamin A, vitamin B1, vitamin B2, vitamin B3, Folic acid, Pantothenic acid, vitamin B6, vitamin B12, vitamin E, vitamin K, Beta-carotene, Biotin, vitamin C Boron, Chromium, Cobalt, Copper, Iodine, Manganese, Molybdenum, Selenium, Silicon, Zinc and Sodium, Potassium, Sulphur, Tin, Vanadium and Nickel.

The inventors have found that bread dough and other yeast products are sensitive to and significantly affected by mineral addition. Simply adding nutritional supplements, such as those for use in drinks, to bread dough does not work effectively.

Considerable skill has to be applied both in the selection and optimal combination of minerals and their salts. Unfortunately it is not possible to simply modify the level of one mineral or its salt without considering the interaction with other co-additions. There may be significant interaction with the constituents of the foodstuff to which the mineral(s) or their salt(s) are added, for example binding to or forming complexes with proteins, polysaccharides, stabilisers or fibre. This in turn may deleteriously affect product attributes such as appearance, taste, flavour, eating and keeping quality. They may also impact on bioavailability or health properties.

Soluble mineral salts can affect the pH of a dough mix which is important to both the quality of the dough and both quality and flavour of the end product. It is preferred therefore that the pH of the premix, dough or end product is from pH 3.0-7.5 and more preferably from pH 4.5-5.8.

According to a second aspect of the invention there is provided a premix comprising at least one source of calcium and at least one source of magnesium characterised in that either: 1) said sources of calcium and magnesium are insoluble or 2) said sources of calcium and magnesium are soluble and the pH when admixed or dissolved in water is from pH 3.0-7.5 or 3) one of said sources of calcium or magnesium is insoluble and one of said sources of calcium or magnesium is soluble and the pH when admixed or dissolved in water is from pH 3.0-7.5.

As used herein the term soluble shall be taken to mean a substance which has a solubility of greater than 0.1 mol/L in water at 25° C. and shall also include partially soluble substances having a solubility of 0.01 mol/L to 0.1 mol/L in water at 25° C. The term insoluble as used herein is defined as a substance which has a solubility of less than 0.01 mol/L in water at 25° C.

The pH may be affected by soluble mineral and mineral desiccant forms such as magnesium sulphate or calcium oxide. Therefore it is desirable to control the pH by the use of additional pH regulator(s). Examples of such additional pH regulators include fruit acids such as citrates and malates or acidity regulators such as ascorbic acid.

The term “fruit acid” refers to organic acid molecules having one or more carboxylic acid groups. Preferably they have acceptable organo-leptic properties, do not have an extreme pH and are preferably solid. Examples include lactic acid, tartaric acid, malic acid, ascorbic acid or citric acid, or acidic salts thereof.

The preferred soluble salts from a nutritional perspective are acid salts of minerals such as calcium lactate, calcium gluconate, calcium lactate gluconate or magnesium lactate which have the advantage of increasing the mineral content further and have little adverse on the resulting product pH.

In a preferred embodiment the source(s) of minerals are insoluble forms such that there is no need for pH regulation.

In the UK there is a statutory requirement for bread flour to be fortified with calcium. It is calculated that such fortification provides about 20% of the recommended daily allowance for calcium, contained in around 240 g of white bread (approximately 6 large slices). An aim of the present invention is to increase this level whilst providing other vitamins and minerals of use in the diet particularly those which impact on bone health.

It is also known that Phytic acids and fibre bind and sequester minerals such as calcium, magnesium and iron forming phytates which limit bioabsorption of these minerals. A solution to this problem would be to consume greater dietary amounts of these minerals.

According to a third aspect of the invention there is provided flour enriched with at least one source of calcium and a source of vitamin D.

According to a fourth aspect of the invention there is provided Flour enriched with at least one source of calcium and at least one source of magnesium.

These aspects are suitable for use in pre-packaged dry mixes such as flour mixes used in home baking and bread machines, pre-prepared cake mixes or in larger volumes for use by craft and master bakers.

The term flour as used herein is defined as a product made from milling or processing grains or other starchy food sources. It includes the entire family of wheat flour products such as Durum flour and shall also be taken to include flour derived from other cereals such as Barley, Corn, Rice or Rye and also includes Soya flour. Equally the term may be used to include other flours such as Potato or Chickpea flour. Preferably the flour is strong flour (high in levels of gluten) from ‘hard’ Wheat varieties but could equally pertain to flour containing added improvers or to flour from ‘soft’ Wheat varieties, low in levels of gluten, for use in cakes and pastries.

According to a fifth aspect of the present invention there is provided a dietary staple enriched with at least one source of calcium and a source of vitamin D.

According to a sixth aspect of the present invention there is provided A dietary staple enriched with at least one source of calcium and at least one source of magnesium characterised in that either 1) said sources of calcium and magnesium are insoluble or 2) said sources of calcium and magnesium are soluble and the pH when admixed or dissolved in water is from pH 3.0-7.5 or 3) one of said sources of calcium or magnesium is insoluble and one of said sources of calcium or magnesium is soluble and the pH when admixed or dissolved in water is from pH 3.0-7.5.

The term dietary staple as used herein is defined as a food product which is eaten on a daily or regular basis as part of the normal diet. As such it may include jams and jellies, sweets and confectionary. More preferably such dietary staples are farinaceous products.

The term ‘farinaceous products’ as used herein is a generic term to describe products made with or containing flour. It shall be taken to include those products sold in the bakery section of supermarkets for example, dough, breads, rolls, pastries, cakes, biscuits, pizzas and pies.

In a preferred embodiment of the present invention said dietary staple is enriched by inclusion of a premix or minerals in its farinaceous component. Alternatively in yet another embodiment the premix may be used to enrich the fillings of such dietary staples for example the jam in doughnuts or the fruit fillings of pies.

An aim of the present invention is to provide around 5-200% RDA of calcium (40-1500 mg) and/or 5-200% RDA of magnesium (15-600 mg) in a daily serving of bread or other dietary staple. More preferably the invention aims to provide around 25-100% RDA of calcium (200-800 mg) and/or 12-70% RDA of magnesium (36-210 mg) in a daily serving of bread or other dietary staple. The most preferred embodiment of the invention will provide around 50% RDA of calcium (400 mg) and/or magnesium (150 mg) in a daily serving of bread or other dietary staple.

In a preferred form a daily serving of bread shall be around 240 g, roughly equivalent to six slices.

More preferably an aim of the present invention is to also provide around 50% RDA of other vitamins and minerals such as iron (7.5 mg), vitamin D (0.0025 mg), vitamin A (0.4 mg), vitamin B1 (0.7 mg), vitamin B3 (9 mg), Folic acid (0.1 mg) and vitamin B12 (0.0005 mg) in a daily serving of bread or other dietary staple. Other embodiments may include other vitamins and trace elements such as Boron, Chromium, Cobalt, Copper, Iodine, Manganese, Molybdenum, Selenium, Silicon, Zinc and Sodium, Potassium, Sulphur, Tin, Vanadium and Nickel.

According to a seventh aspect of the present invention there is provided a granular premix comprising nutritional additives including a calcium salt and optionally a magnesium salt wherein the one or more salts are enrobed in a constituent such that the salts are bound in an extrudable mass which is formed into granules.

In a more preferred embodiment said salts are insoluble and the granular premix is largely insoluble retaining its form when mixed with other ingredients. Said granular premix could be used as artificial grains in for example granary bread, as an alternative to chocolate chips in cakes and desserts or as a coating or inclusions in confectionary and sweets.

Still yet further aspects of the present invention provide methods of making premixes and methods of enriching flour or dietary staples with premixes or minerals.

Still yet further aspects of the present invention provide the use of premixes for enriching flour or dietary staples with premixes or minerals.

### BEST MODES FOR CARRYING OUT THE INVENTION

The varying aspects of the invention will now be described, by way of example only, with reference to the following example compositions and supporting data.

### EXAMPLE 1

Preparation of Premixes

Premixes were prepared with differing sources of calcium and/or magnesium as in table 2:

| Source | | A | B | C | D | E | F | G | H | I | J | K |
|---|---|---|---|---|---|---|---|---|---|---|---|---|
| E529 | Calcium Oxide | | ✓ | | ✓ | ✓ | ✓ | ✓ | ✓ | ✓ | ✓ | ✓ |
| E341 | Calcium phosphate | | | | | | ✓ | | ✓ | | | |
| E170 | Calcium Carbonates | ✓ | ✓ | | | ✓ | ✓ | ✓ | ✓ | ✓ | ✓ | ✓ |
| E327 | Calcium Lactate | | | | | | | | | | ✓ | |
| E504 | magnesium Carbonate | | | ✓ | | ✓ | ✓ | | | ✓ | ✓ | ✓ |
| E518 | magnesium Sulphate | | | ✓ | ✓ | ✓ | ✓ | ✓ | ✓ | ✓ | ✓ | ✓ |
| E343 | Di-magnesium | | | | | | | ✓ | ✓ | | | |
| | phosphate | | | | | | | | | | | |
| | magnesium Lactate | | | | | | | | | | | ✓ |
| iron | iron powder | | ✓ | ✓ | ✓ | | ✓ | ✓ | ✓ | ✓ | ✓ | ✓ |
| Vit B1 | Thiamin | | ✓ | ✓ | ✓ | | ✓ | ✓ | ✓ | ✓ | ✓ | ✓ |
| Vit B3 | Niacin | | ✓ | ✓ | ✓ | | ✓ | ✓ | ✓ | ✓ | ✓ | ✓ |
| Vit M/Bc | Folic Acid | | ✓ | ✓ | ✓ | ✓ | ✓ | ✓ | ✓ | ✓ | ✓ | ✓ |
| Vit B12 | Cyanobalamin | | ✓ | ✓ | ✓ | ✓ | ✓ | ✓ | ✓ | ✓ | ✓ | ✓ |
| Vit D | Cholecalciferol | | ✓ | ✓ | ✓ | ✓ | ✓ | ✓ | ✓ | ✓ | ✓ | ✓ |

A represents additives included in a standard white loaf (by statute fortified with calcium, iron, thiamine and niacin. The novel premixes B-K comprise at least one source of calcium and a source of vitamin D or an alternative premix comprises at least one source of calcium and at least one source of magnesium or magnesium alone. If desired the premix may also comprise pH regulators such as ascorbic acid or citric acid and additional vitamins or minerals.

In this example, premixes are prepared by admixing the mineral and vitamin sources to produce a powder product which may optionally be dissolved or dispersed further in a liquid carrier.

### EXAMPLE 2

Method of Making a Substantially Granular Premix

A substantially granular premix is produced by admixing any of the premixes of example 1 with a binder sufficient to form a soft extrudable mass. The binder may include for example vegetable oils or fats, molasses or even melted chocolate. Optional ingredients may be added to enhance the texture or flavour such as malt fibre or wheat extract. The premix and other ingredients are admixed to produce a consistency which can be extruded and shaped by pressing through a sieve or a conventional mechanical extruder and chopped or otherwise granulated.

The process produces solid granules which in a preferred embodiment are not readily dispersible and may be dried and are suitable for inclusion in farinaceous products and more preferably flour or breads forming for example artificial grains.

### EXAMPLE 3

Method of Making Flour and Farinaceous Products with Enhanced Mineral Content

To enhance the mineral and vitamin content of flour or farinaceous products, the premix or individual components may be admixed with the flour or other ingredients at any stage of processing. When added to flour a desiccant effect of some sources of calcium and/or magnesium help to maintain the flour as a free flowing powder without caking or lumps, for example making said premixes useful in dry flour mixes for home baking or in larger sizes for master and craft bakers.

By way of example, the mineral premixes of examples 1 or 2 may be added to the following ingredients to produce bread with an enhanced mineral and vitamin content:

| | | |
|---|---|---|
| Flour (Premium Strong) | 8000 | g |
| Water | 4750 | ml |
| Salt | 66.4 | g |
| Yeast (fresh) | 250 | g |
| Improver | 100 | g |
| Soya Flour | 60 | g |

The mineral premix of Example 1 or 2 is mixed with flour, flour Improver and yeast in a spiral mixer until fully incorporated. Chilled water is added with stirring and mixed for 2 minutes at a low speed followed by 6 minutes on a higher speed to produce a dough.

Dough is left for an intermediate proving at 21° C. for 6-8 minutes and then divided, moulded (rolled) and placed into tins. Dough is left to prove for a further 60-75 minutes at 40° C. prior to baking at 225-240° C. for 30 minutes.

### EXAMPLE 4

Determining the Effect of Mineral Addition on Baking Quality

The following trial determines the effect of calcium and/or magnesium addition to dough mixes and bread products. Premixes were prepared by mixing the following. Quantities are by weight in grammes.

| | A | B | C | D |
|---|---|---|---|---|
| Calcium Oxide | — | 0.578 | — | 0.578 |
| Calcium Carbonate | 114.49 | 35.148 | — | 35.148 |
| magnesium carbonate | — | — | 34.526 | 34.526 |
| magnesium Sulphate | — | — | 0.952 | 0.952 |
| (exsiccated) | | | | |
| iron | — | 0.294 | 0.294 | 0.294 |
| Vit B1 | — | 0.013 | 0.013 | 0.013 |
| Vit B3 | — | 0.398 | 0.398 | 0.398 |
| Vit M/Bc | — | 0.008 | 0.008 | 0.008 |
| Vit B12 | — | 0.04 | 0.04 | 0.04 |
| Vit D | — | 0.059 | 0.059 | 0.059 |
| Vit A | — | 0.812 | 0.812 | 0.812 |
| Total: | 114.49 | 37.35 | 37.102 | 73.122 |

To prepare additionally fortified flour the total weights of the premix were individually admixed with 8 Kg of flour.

Four types of white bread were prepared. The composition of each of the bread types was the same except each type of bread was fortified with a different premix of Example 1, either A, B, C or D.

| | | |
|---|---|---|
| Flour (Premium Strong) | 8000 | g |
| Water | 4750 | ml |
| Salt | 66.4 | g |
| Yeast (fresh) | 250 | g |
| Improver | 100 | g |
| Soya Flour | 60 | g |

The respective mineral premix (either A, B, C or D) was mixed with the flour, flour Improver and yeast in a spiral mixer until fully incorporated. Chilled water was added with stirring and mixed on a low speed for 2 minutes followed by 6 minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

A represents the prior art and reproduces the composition of bread commonly available for sale. Here it acts as a control against which other loaves are compared. Loaves produced containing either premix A or B were of good quality. Loaves produced with premix C or D containing substantial amounts of soluble magnesium were poor with low volume and rise, poor crumb colour and flavour and an increased loaf pH of around 8 units compared to the control loaf with a pH of around 5-6. This result suggests that the soluble magnesium salts are interfering with loaf quality.

### EXAMPLE 5

Trial to Determine the Effects of Acidity Regulators on Loaves Containing Premixes.

Premixes were prepared by mixing the following. Quantities are by weight in grammes.

| | E1 | E2 | E3 | E4 |
|---|---|---|---|---|
| Calcium Oxide | 0.578 | 0.578 | 0.578 | 0.578 |
| Calcium phosphate | — | — | — | — |
| Calcium carbonate | 35.148 | 35.148 | 35.148 | 35.148 |
| magnesium carbonate | 34.526 | 34.526 | 34.526 | 34.526 |
| magnesium Sulphate | 0.952 | 0.952 | 0.952 | 0.952 |
| (exsiccated) | | | | |
| Ascorbic Acid | 1.000 | 4.000 | — | — |
| Citric Acid | — | — | 1.000 | 4.000 |
| iron | 0.294 | 0.294 | 0.294 | 0.294 |
| Vit B1 | 0.013 | 0.013 | 0.013 | 0.013 |
| Vit B3 | 0.398 | 0.398 | 0.398 | 0.398 |
| Vit M/Bc | 0.008 | 0.008 | 0.008 | 0.008 |
| Vit B12 | 0.04 | 0.04 | 0.04 | 0.04 |
| Vit D | 0.059 | 0.059 | 0.059 | 0.059 |
| Vit A | 0.812 | 0.812 | 0.812 | 0.812 |
| Total: | 73.828 | 76.828 | 73.828 | 76.828 |

To prepare additionally fortified flour the total weights of the premix were individually admixed with 8 Kg of flour.

Four types of white bread were prepared. The composition of each of the bread types was the same except each type of bread was fortified with a different premix of Example 5, either E1, E2, E3 or E4:

| | | |
|---|---|---|
| Flour (Premium Strong) | 4000 | g |
| Water | 2375 | ml |
| Salt | 33.2 | g |
| Yeast (fresh) | 125 | g |
| Improver | 50 | g |

The mineral premix was mixed with the flour, flour Improver and yeast in a spiral mixer until fully incorporated. Chilled water was added with stirring and mixed for 2 minutes on a low speed followed by 6 minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

All the loaves when cooled and sliced had a yellow crumb colour and a ‘baking powder’ chemical smell, they tasted bland (low salt). The overall quality of the loaves with mineral premix and acidity regulators were however improved over loaves containing mineral premix alone. The premixes containing Citric acid produced the best overall loaf volume. This example demonstrates the need for pH control in preparing good quality loaves.

### EXAMPLE 6

Trial to Determine the Effect of Increasing Levels of Citric Acid on Quality of Loaves Containing Mineral Premixes

Fortified white bread loaves were prepared to demonstrate the effect of varying levels of citric acid within the premix on baking quality.

Premixes were prepared by mixing the following. Quantities are by weight in grammes.

| | E16G | E32G | E48G |
|---|---|---|---|
| Calcium Oxide | 0.578 | 0.578 | 0.578 |
| Calcium phosphate | — | — | — |
| Calcium carbonate | 35.148 | 35.148 | 35.148 |
| magnesium carbonate | 34.526 | 34.526 | 34.526 |
| magnesium Sulphate | 0.952 | 0.952 | 0.952 |
| Citric Acid | 16.000 | 32.000 | 48.000 |
| iron | 0.294 | 0.294 | 0.294 |
| Vit B1 | 0.013 | 0.013 | 0.013 |
| Vit B3 | 0.398 | 0.398 | 0.398 |
| Vit M/Bc | 0.008 | 0.008 | 0.008 |
| Vit B12 | 0.04 | 0.04 | 0.04 |
| Vit D | 0.059 | 0.059 | 0.059 |
| Vit A | 0.812 | 0.812 | 0.812 |
| Total: | 88.828 | 104.828 | 120.828 |

Four types of white bread were prepared. The composition of each of the bread types was the same except each type of bread was fortified with a different premix either E16G, E32G or E48G.

| | | |
|---|---|---|
| Flour (Premium Strong) | 8000 | g |
| Water | 5000 | ml |
| Salt | 66.4 | g |
| Yeast (fresh) | 250 | g |
| Improver | 100 | g |

The respective mineral premix was mixed with the flour, flour Improver and yeast in a spiral mixer until fully incorporated. Chilled water was added with stirring and mixed for 2 minutes on a low speed followed by 6 minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

The addition of citrate had a direct effect resulting in a stickier dough. Overall, increasing the level of Citrate to 16 g produced good quality loaves but at 24 g the loaf texture was too open.

### EXAMPLE 7

Trial to Determine the Optimum Level of Citric Acid on Quality of Loaves Containing Mineral Premixes.

Fortified white bread loaves were prepared to demonstrate the effect of varying levels of citric acid within the premix on baking quality and to determine the optimal level of citric acid.

Premixes were prepared by mixing the following. Quantities are by weight in grammes.

| | E24G | E34G | E44G |
|---|---|---|---|
| Calcium Oxide | 0.578 | 0.578 | 0.578 |
| Calcium phosphate | — | — | — |
| Calcium carbonate | 35.148 | 35.148 | 35.148 |
| magnesium carbonate | 34.526 | 34.526 | 34.526 |
| magnesium Sulphate | 0.952 | 0.952 | 0.952 |
| Citric Acid | 24.000 | 34.000 | 44.000 |
| iron | 0.294 | 0.294 | 0.294 |
| Vit B1 | 0.013 | 0.013 | 0.013 |
| Vit B3 | 0.398 | 0.398 | 0.398 |
| Vit M/Bc | 0.008 | 0.008 | 0.008 |
| Vit B12 | 0.04 | 0.04 | 0.04 |
| Vit D | 0.059 | 0.059 | 0.059 |
| Vit A | 0.812 | 0.812 | 0.812 |
| Total: | 96.828 | 106.828 | 116.828 |

Four types of white bread were prepared. The composition of each of the bread types was the same except each type of bread was fortified with a different premix either E24G, E34G or E44G.

| | | |
|---|---|---|
| Flour (Premium Strong) | 8000 | g |
| Water | 5000 | ml |
| Salt | 66.4 | g |
| Yeast (fresh) | 250 | g |
| Improver | 100 | g |

The respective mineral premix was mixed with the flour, flour Improver and yeast in a spiral mixer until fully incorporated. Chilled water was added with stirring and mixed for 2 minutes on a low speed followed by 6 minutes on a higher speed to produce a dough.

Dough was left for an intermediate proving at 21° C. for 6-8 minutes and then divided, moulded (rolled) and placed into tins. Dough was left to prove for a further 1 hour 15 minutes at 40° C. prior to baking at 225-240° C. for 30 minutes. The loaves were analysed with respect to pH, rise, colour, shape and crumb.

The addition of citrate had a direct effect again resulting in a stickier dough. Loaves containing 24 or 34 grammes of citrate had a quicker proving time but above 34 g of citrate the gluten structure did not develop properly. Addition of citrate was successful in counteracting the effect of soluble magnesium salts producing loaves with a pH of from pH 6.5-7.5 but stickiness led to processing problems.

### EXAMPLE 8

Trial Examining the Effect of Calcium or Magnesium Lactate on Baking Quality of Loaves Containing Mineral Premixes.

Premixes were prepared by mixing the following. Quantities are by weight in grammes.

| | J | K |
|---|---|---|
| Calcium Oxide | 0.578 | 0.578 |
| Calcium phosphate | — | — |
| Calcium carbonate | 29.928 | 35.148 |
| Calcium Lactate | 14.12 | — |
| magnesium carbonate | 34.526 | 1.062 |
| magnesium Sulphate | 0.952 | 0.952 |
| (exsiccated) | | |
| magnesium Lactate | — | 49.169 |
| iron | 0.294 | 0.294 |
| Vit B1 | 0.013 | 0.013 |
| Vit B3 | 0.398 | 0.398 |
| Vit M/Bc | 0.008 | 0.008 |
| Vit B12 | 0.04 | 0.04 |
| Vit D | 0.059 | 0.059 |
| Vit A | 0.812 | 0.812 |
| Total: | 81.728 | 88.533 |

To prepare fortified flour the total weights of the premix were individually admixed with 8 Kg of flour.

Two types of white bread were prepared. The composition of each of the bread types was the same except each type of bread was fortified with a different premix containing calcium or magnesium Lactate; J or K respectively.

| | | |
|---|---|---|
| Flour (Premium Strong) | 4000 | g |
| Water | 2375 | ml |
| Salt | 33.2 | g |
| Yeast (fresh) | 125 | g |
| Improver | 50 | g |

Half the premix treated flour (4 Kg) was mixed with the flour, flour Improver and yeast in a spiral mixer until fully incorporated. Chilled water was added with stirring and mixed for 2 minutes on a low speed followed by 6 minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

The loaves produced were good, with acceptable pH around pH 5.9, rise and acceptable smell and taste.

### EXAMPLE 9

Trial Examining the Acidulant Effect of Soluble Calcium Phosphate on Baking Quality of Loaves Containing Mineral Premixes.

Fortified white bread loaves were prepared to demonstrate the effect of varying levels of calcium phosphate monohydrate (monobasic) within the premix on baking quality and to determine the optimal level of calcium phosphate monohydrate (monobasic).

Premixes were prepared by mixing the following. Quantities are by weight in grammes.

| | M6G | M12G | M18G | M24G | M30G |
|---|---|---|---|---|---|
| Calcium oxide | 0.29 | 0.29 | 0.29 | 0.29 | 0.29 |
| Calcium phosphate | 5.99 | 11.99 | 17.99 | 23.89 | 30.00 |
| Calcium carbonate | 14.96 | 12.35 | 9.66 | 6.87 | 4.1 |
| Magnesium carbonate | 16.997 | 16.997 | 16.997 | 16.997 | 16.997 |
| Magnesium sulphate | 0.952 | 0.952 | 0.952 | 0.952 | 0.952 |
| Iron | 0.147 | 0.147 | 0.147 | 0.147 | 0.147 |
| Vit B1 | 0.007 | 0.007 | 0.007 | 0.007 | 0.007 |
| Vit B3 | 0.199 | 0.199 | 0.199 | 0.199 | 0.199 |
| Vit M/Bc | 0.004 | 0.004 | 0.004 | 0.004 | 0.004 |
| Vit B12 | 0.02 | 0.02 | 0.02 | 0.02 | 0.02 |
| Vit D | 0.03 | 0.03 | 0.03 | 0.03 | 0.03 |
| Total: | 39.607 | 42.994 | 46.295 | 49.41 | 52.271 |

Five types of white bread were prepared. The composition of each of the bread types was the same except each type of bread was fortified with a different premix either M6G, M12G, M18G, M24G and M30G.

| | | |
|---|---|---|
| Flour (Premium Strong) | 4000 | g |
| Water | 2500 | ml |
| Salt | 33.2 | g |
| Yeast (fresh) | 125 | g |
| Improver | 50 | g |

The respective mineral premix was mixed with the flour, flour Improver and yeast in a spiral mixer until fully incorporated. Chilled water was added with stirring and mixed for 2 minutes on a low speed followed by 6 minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

The addition of increasing levels of calcium phosphate monohydrate (monobasic) gave better colour, rise and taste. Loaves containing 24 or 30 grammes of calcium phosphate monohydrate (monobasic) were successful in counteracting the effect of soluble magnesium salts producing loaves with a pH of from pH6.5-7.5.

### EXAMPLE 10

Trial Examining the Effect of Soluble Forms of Calcium Phosphates and Insoluble Magnesium Phosphates on Baking Quality of Loaves Containing Mineral Premixes.

Fortified white bread loaves were prepared to demonstrate the effect on baking quality of combining magnesium phosphate trihydrate (dibasic), as a replacement for magnesium carbonate, with calcium phosphate monohydrate (monobasic), within the premix.

Premixes were prepared by mixing the following. Quantities are by weight in grammes and also shown in percentage amounts.

| | DM31G | % | DM41G | % |
|---|---|---|---|---|
| Calcium oxide | 0.29 | 0.459 | 0.29 | 0.382 |
| Calcium phosphate | 24.0 | 38.11 | 24.0 | 31.77 |
| Calcium carbonate | 6.8 | 10.94 | 19.314 | 25.58 |
| Magnesium sulphate | 0.48 | 0.756 | 0.48 | 0.630 |
| Di Magnesium phosphate | 31.0 | 49.099 | 30.89 | 40.91 |
| Iron | 0.147 | 0.234 | 0.216 | 0.286 |
| Vit B1 | 0.007 | 0.011 | 0.019 | 0.026 |
| Vit B3 | 0.199 | 0.316 | 0.265 | 0.352 |
| Vit M/Bc | 0.004 | 0.007 | 0.004 | 0.006 |
| Vit B12 | 0.02 | 0.031 | 0.02 | 0.026 |
| Vit D | 0.03 | 0.047 | 0.03 | 0.039 |
| Total: | 62.971 | 99.99 | 46.295 | 100.01 |

Two types of bread were prepared using white and wholemeal flour. The composition of each of the bread types was the same except each type of flour was fortified with a different premix: white flour used DM31 g and wholemeal flour DM41 g.

| | | |
|---|---|---|
| Flour (Premium Strong) | 4000 | g - white or wholemeal |
| Water | 2500 | ml |
| Salt | 33.2 | g |
| Yeast (fresh) | 125 | g |
| Improver | 50 | g |

The respective mineral premix was mixed with the appropriate flour—DM31 G with white flour; DM41 g with wholemeal flour—flour Improver and yeast in a spiral mixer until fully incorporated. Chilled water was added with stirring and mixed for 2 minutes on a low speed followed by 6 minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

The combination of magnesium phosphate trihydrate (dibasic) with calcium phosphate monohydrate (monobasic), with both white and wholemeal flours gave excellent results with good rise, acceptable taste and soft crumb and a resulting pH <5.75 for each type. Some larger crumb air cells were present.

### EXAMPLE 11

Trial Examining the Effect of Insoluble Forms of Calcium and/or Magnesium on Baking Quality of Loaves Containing Mineral Premixes.

Fortified bread loaves were prepared to demonstrate the effect on baking quality of combining insoluble magnesium phosphate trihydrate (dibasic) with calcium carbonate (Creta Praeparatum) within the premix.

Premixes were prepared by mixing the following. Quantities are by weight in grammes and also shown in percentage amounts.

| | D/Ci | % | D/Cii | % | D/Ciii | % |
|---|---|---|---|---|---|---|
| Calcium oxide | 0.289 | 0.581 | 0.289 | 0.382 | 0.254 | 0.581 |
| Calcium carbonate | 17.66 | 35.51 | 30.1 | 48.30 | 15.51 | 35.514 |
| Magnesium sulphate | 0.476 | 0.957 | 0.476 | 0.764 | 0.418 | 0.9571 |
| Di Magnesium phosphate | 30.89 | 62.134 | 30.89 | 49.58 | 27.142 | 62.13 |
| Iron | 0.147 | 0.295 | 0.216 | 0.346 | 0.129 | 0.296 |
| Vit B1 | 0.007 | 0.014 | 0.019 | 0.031 | 0.006 | 0.014 |
| Vit B3 | 0.199 | 0.400 | 0.265 | 0.426 | 0.175 | 0.4003 |
| Vit M/Bc | 0.004 | 0.039 | 0.004 | 0.007 | 0.0037 | 0.0084 |
| Vit B12 | 0.02 | 0.031 | 0.02 | 0.032 | 0.0018 | 0.0399 |
| Vit D | 0.03 | 0.059 | 0.03 | 0.048 | 0.026 | 0.0595 |
| Total: | 49.73 | 100.04 | 62.35 | 100.00 | 174.68 | 100.0 |

Two types of bread were prepared using white and wholemeal flour. The composition of each of the bread types was the same except each type of flour was fortified with a different premix: white flour used DCi and DCiii and wholemeal flour DCii and DCiii.

| | | |
|---|---|---|
| Flour (Premium Strong) | 4000 | g - white or wholemeal |
| Water | 2500 | ml |
| Salt | 33.2 | g |
| Yeast (fresh) | 125 | g |
| Improver | 50 | g |

The respective mineral premix was mixed with the appropriate flour—DMi and DCiii G with white flour; DCii and DCiii with wholemeal flour—flour Improver and yeast in a spiral mixer until fully incorporated. Chilled water was added with stirring and mixed for 2 minutes on a low speed followed by 6minutes on a higher speed to produce a dough.

Dough was left for an intermediate proving at 21° C. for 6-8 minutes and then divided, moulded (rolled) and placed into tins. Dough was left to prove for a further 60-75 minutes at 40° C. prior to baking at 225-240° C. for 30 minutes. The loaves were analysed with respect to pH, rise, colour, shape and crumb.

The combination of magnesium phosphate trihydrate (dibasic) with calcium carbonate (creta praeparatum), with both white and wholemeal flours gave excellent results with good rise, acceptable taste and soft crumb texture and a resulting pH<5.8 for each type. The crumb structure was even and regular—the flavour and taste was a slightly bland due to the low salt level.

### EXAMPLE 12

Demonstrating the Formation of Granular Premixes

Premixes of Example 1 were admixed with wheat fibre, molasses, oligosacharride syrup or malt extract and sufficient water was added to form a soft, extrudable mass. The mass was granulated by pressing through a sieve or using a conventional mechanical extruder. Drying of the granules produced ‘nutty’ flavoured inclusions suitable for use as an artificial grain in farinaceous products such as wholemeal bread.

As an alternative, with a fat continuous phase, to prevent assimilation in more moist products, molten chocolate was used to bind the premixes prior to granulation. On hardening of the granular premix it was used for inclusion in confectionary products to enhance their mineral content.

### EXAMPLE 13

Trial Demonstrating the Incorporation of Minerals in Confectionary.

The premixes of Example 1 were used to enhance the mineral content of confectionary and sweets.

| | C1 | | C2 | | C3 | | C4 | |
|---|---|---|---|---|---|---|---|---|
| Premix | 1 | g | 1 | g | 1 | g | 1 | g |
| Cornflour | 10 | g | 10 | g | — | | — | |
| Acacia Gum | — | | 2 | g | — | | — | |
| Sugar | 10 | g | — | | 45 | g | — | |
| Xylitol | — | | 10 | g | — | | 45 | g |
| Glucose Syrup | — | | — | | 25 | g | — | |
| Oligosac- | — | | — | | — | | 250 | g |
| charide Syrup | | | | | | | | |
| Gelatine | — | | — | | 3 | g | 3 | g |
| Liquorice | 5 | g | — | | — | | — | |
| Extract | | | | | | | | |
| Oil of Aniseed | 0.1 | g | — | | 0.1 | g | — | |
| Oil of | — | | 0.1 | g | — | | 0.1 | g |
| Peppermint | | | | | | | | |
| Glycerol | 5 | g | 5 | g | — | | — | |
| Water | to 100 | ml | to 100 | ml | to 100 | ml | to 100 | ml |

Formulation 2 and 4 contain Xylitol in place of sugar and demonstrate non-cariogenic forms of confectionary.

Dry ingredients of C1 or C2 were admixed thoroughly and water and glycerol were added to form a paste. The mixture was heated on a water bath until a smooth, gelatinous mass formed. Oil of Aniseed or other flavourings were added. Whilst hot the ‘plastic mass’ was poured into moulds to form decorative shapes.

Marshmallow type confectionary was produced using the ingredients of C3 or C4. Gelatine was added to cold water until the water was fully absorbed. Other ingredients were admixed and the mixture was heated until fully amalgamated. The mass was beaten in a high energy mixer to incorporate air and cast in icing sugar dusted moulds to form marshmallows.

1. A premix consisting essentially of minerals including at least one source of Calcium and a source of vitamin D.

2. The premix according to claim 1 which further comprises at least one source of magnesium.

3. The premix according to claim 1 which further comprises at least one source of phosphorous.

4. The premix according to claim 1 further comprises at least one source of iron.

5. The premix according to claim 1 wherein said at least one source of calcium is selected from the group consisting of: calcium acetate, calcium magnesium acetate, calcium alginate, calcium ascorbate, calcium benzoate, calcium butyrate, calcium carbonate, calcium magnesium carbonate, calcium chloride, calcium citrate, calcium magnesium citrate, calcium cylclamate, calcium diglutamate, calcium formate, calcium fumarate, calcium gluconate, calcium glycerophosphate, calcium hydroxide, calcium hydroxide carbonate, calcium iodate, calcium lactate, calcium lactate gluconate, calcium malates, calcium malonate, calcium oleate, calcium oxalate, calcium oxide, calcium palmitate, calcium phosphate (tribasic), calcium monohydrogen phosphate (dibasic), calcium dihydrogen phosphate (monobasic), calcium phosphite, calcium phytate, calcium polyphosphate, calcium proprionate, calcium pyrophosphate, calcium D-saccharate, calcium silicate, calcium sorbate, calcium stearate, calcium stearoyl-2-lactylate, calcium succinate, calcium sulphate, calcium tartrate, and calcium valerate and combinations thereof

6. The premix according to claim 2 wherein said at least one source of magnesium is selected from the group consisting of: magnesium acetate, magnesium butyrate, magnesium carbonates, magnesium carbonate hydroxide, magnesium chloride, magnesium citrate, magnesium citrate (dibasic), magnesium formate, magnesium fumarate, magnesium hydroxide, magnesium hydroxide carbonate, magnesium lactate, magnesium malate, magnesium malonate, magnesium oxalate, magnesium oxide, magnesium phosphate (tribasic), magnesium monohydrogen phosphate (dibasic), magnesium dihydrogen phosphate (monobasic), magnesium phytate, magnesium phosphite, magnesium polyphosphate, magnesium proprionate, magnesium pyrophosphate, magnesium succinate, magnesium sulphate, magnesium stearate, magnesium tartrate, magnesium valerate and calcium magnesium carbonate and combinations thereof.

7. The premix according to claim 3 wherein said at least one source of phosphorous is selected from the group consisting of: magnesium phosphate (tribasic), magnesium monohydrogen phosphate (dibasic), magnesium dihydrogen phosphate (monobasic), magnesium Phosphite, magnesium polyphosphate and magnesium pyrophosphate: calcium phosphate (tribasic), calcium monohydrogen phosphate (dibasic), calcium dihydrogen phosphate (monobasic), calcium Phosphite, and calcium polyphosphate and calcium pyrophosphate and combinations thereof.

8. The premix according to claim wherein said at least one source of iron is selected from the group consisting of: micronised elemental iron, iron Sulphate, iron fumarate, iron pyrophosphate and ammonium ferric citrate and combinations thereof.

9. The premix according to claim 1 which further comprises at least one other source of vitamins or minerals selected from the group consisting of: Boron, Chromium, Cobalt, Copper, Iodine, Manganese, Molybdenum, Nickel, Potassium, Selenium, Sodium, Sulphur, Tin, Vanadium, Zinc, vitamin A, vitamin B1, vitamin B2, vitamin B3, vitamin B5, vitamin B6, vitamin B 12, vitamin C vitamin E, vitamin K, Beta-carotene, Biotin and Folic acid and combinations thereof.

10. The premix according to claim 1 having a mineral content of not less than 70% by weight and more preferably not less than 80% by weight and most preferably not less than 90% by weight.

11. The premix as claimed in claim 1 wherein: 1) said at least one source of calcium, and where present magnesium, is insoluble or 2) Said at least one source of calcium, and where present magnesium, is soluble and the pH when admixed or dissolved in water is from pH 3.0-7.5 or 3) at least one source of calcium, or where present magnesium, is insoluble and at least one source of calcium, or where present magnesium, is soluble and the pH when admixed or dissolved in water is from pH 3.0-7.5.

12. A premix comprising at least one source of Calcium and at least one source of magnesium characterised in that either: 1) said sources of calcium and magnesium are insoluble or 2) said sources of calcium and magnesium are soluble and the pH when admixed or dissolved in water is from pH 3.0-7.5 or 3) one of said sources of calcium or magnesium is insoluble and one of said sources of calcium or magnesium is soluble and the pH when admixed or dissolved in water is from pH 3.0-7.5.

13. The premix according to claim 12 which further comprises a pH control agent which alters the pH of the premix to between pH 3.0 and 7.5 when admixed or dissolved in water.

14. The premix according to claim 12 wherein the pH when admixed or dissolved in water is from pH 5.0-7.0.

15. The premix according to claim 11 wherein said pH control agent is either an acid or an acid salt.

16. Flour enriched with a premix according to claim 1.

17. Flour enriched with at least one source of calcium and a source of vitamin D.

18. Flour enriched with at least one source of Calcium and at least one source of magnesium.

19. Flour according to claim 17 wherein:
1) said sources of calcium and where present magnesium are insoluble or
2) said sources of calcium and where present magnesium are soluble and the pH when admixed or dissolved in water is from pH 3.0-7.5 or
3) one of said sources of calcium or where present magnesium is insoluble and one of said sources of calcium or where present magnesium is soluble and the pH when admixed or dissolved in water is from pH 3.0-7.5.

20. Flour according to claim 1 wherein said flour is wheat flour.

21. A dietary staple obtained from a premix according to claim 1.

22. A dietary staple enriched with at least one source of calcium and a source of vitamin D.

23. A dietary staple enriched with at least one source of Calcium and at least one source of magnesium characterised in that either:
1) said sources of calcium and magnesium are insoluble or
2) said sources of calcium and magnesium are soluble and the pH when admixed or dissolved in water is from pH 3.0-7.5 or
3) one of said sources of calcium or magnesium is insoluble and one of said sources of calcium or magnesium is soluble and the pH when admixed or dissolved in water is from pH 3.0-7.5.

24. The dietary staple according to claim 23 wherein said dietary staple is a farinaceous product.

25. The dietary staple of claim 24 wherein said farinaceous product is dough or a bread product.

26. The dietary staple of claim 24 wherein said farinaceous product is a pasta product.

27. The dietary staple according to claim 23 enriched with a level of Calcium of between 35-340 mg per 100 g of dietary staple and/or a level of magnesium of between 12-125 mg per 100 g of dietary staple.

28. The dietary staple of claim 27 wherein the level of Calcium is between 75-235 mg per 100 g of dietary staple and/or a level of magnesium of between 15-87.5 mg per 100 g of product.

29. A dietary staple of claim 23 with a level of calcium and/or a level of magnesium of around 25-100% RDA and more preferably from 25-70% RDA in a daily dose of said dietary staple.

30. A granular premix comprising nutritional additives including an insoluble calcium salt and optionally an insoluble magnesium salt wherein the one or more salts are enrobed in a constituent such that the salts are bound in an extrudable mass which is formed into granules.

31. The granular premix of claim 30 wherein said constituent is selected from the group consisting of: molasses, syrup, oligosaccharide syrup, fat continuous phase, high melting point fat and chocolate and combinations thereof.

32. A method of enriching the mineral content of flour comprising the step of adding the granular premix of claim 30 to flour.

33. A method of making a dietary staple enriched with the granular premix of claim 30 comprising admixing said granular premix with ingredients of said dietary staple at any stage of processing said dietary staple.

34. A method of enriching a dietary staple with the granular premix of claim 30 comprising coating said dietary staple with the granular premix.

35. A method of enriching the mineral content of flour comprising the step of adding a premix according to claim 1 to flour.

36. A method of enriching flour with at least one source of calcium and a source of vitamin D comprising admixing.

37. A method of enriching flour with at least one source of Calcium and at least one source of magnesium characterised in that either 1) said sources of Calcium and magnesium are insoluble or 2) said sources of Calcium and magnesium are soluble and the pH when admixed or dissolved in water is from pH 3.0-7.5 or 3) one of said sources of calcium or magnesium is insoluble and one of said sources of calcium or magnesium is soluble and the pH when admixed or dissolved in water is from pH 3.0-7.5 comprising admixing.

38. A method of making a dietary staple as claimed in claim 23 comprising admixing said premix with ingredients of said dietary staple at any stage of processing said dietary staple.

39. A method of making a dietary staple enriched with at least one source of calcium and a source of vitamin D comprising admixing said at least one source of calcium and said source of vitamin D with ingredients of said dietary staple at any stage of processing said dietary staple

40. A method of making a dietary staple enriched with a premix comprising at least one source of Calcium and at least one source of magnesium characterised in that either 1) said sources of Calcium and magnesium are insoluble or 2) said sources of Calcium and magnesium are soluble and the pH when admixed or dissolved in water is from pH 3.0-7.5 or 3) one of said sources of calcium or magnesium is insoluble and one of said sources of calcium or magnesium is soluble and the pH when admixed or dissolved in water is from pH 3.0-7.5 consisting of the following steps: Admixing said at least one source of calcium and said at least one source of magnesium with ingredients of said dietary staple at any stage of processing said dietary staple.

41. The use of a premix according to claim 1 to enhance the mineral content of flour.

42. The use of a premix according to claim 1 to enhance the mineral content of a dietary staple.

43. The use of a premix according to claim 1 in the production of a dietary staple.

44. The use of flour according to claim 16 in the production of a dietary staple.

45. The use of a granular premix according to claim 30 to enhance the mineral content of flour.

46. The use of a granular premix according to claim 30 to enhance the mineral content of a dietary staple.

47. The use of a granular premix according to claim 30 in the production of a dietary staple.

48. Use according to claim 41 wherein said dietary staple is a farinaceous product.

49. Use according to claim 48 wherein said farinaceous product is dough or a bread product.

50. The premix according to claim 12 wherein said pH control agent is either an acid or an acid salt.

51. Flour according to claim 18 wherein: 1) said sources of calcium and where present magnesium are insoluble or 2) said sources of calcium and where present magnesium are soluble and the pH when admixed or dissolved in water is from pH 3.0-7.5 or 3) one of said sources of calcium or where present magnesium is insoluble and one of said sources of calcium or where present magnesium is soluble and the pH when admixed or dissolved in water is from pH 3.0-7.5.

52. A dietary staple obtained from a premix according to claim 16.
